(19) United States
(12) Patent Application Publication
(10) Pub. No.: US 2018/0174772 A1
(43) Pub. Date: Jun. 21, 2018

(54) SWITCH

(71) Applicant: OMRON Corporation, Kyoto-shi (JP)

(72) Inventors: Hiroyuki FUJITA, Okayama-shi (JP); Kazushi MAETA, Tohaku-gun (JP)

(73) Assignee: OMRON Corporation, Kyoto-shi (JP)

(21) Appl. No.: 15/899,466

(22) Filed: Feb. 20, 2018

Related U.S. Application Data
(63) Continuation of application No. PCT/JP2016/084662, filed on Nov. 22, 2016.

(30) Foreign Application Priority Data
Feb. 29, 2016 (JP) 2016-038055

(51) Int. Cl. H01H 1/36; H01H 13/10; H01H 13/52; H01H 13/14

(52) U.S. Cl. CPC H01H 1/36; H01H 13/10; H01H 1/5866; H01H 13/14; H01H 13/52

(57) ABSTRACT

A switch includes a first fixed terminal, a second fixed terminal, and a slider. The slider includes an energizing movable contact portion and two opening/closing movable contact portions which are separated from each other. In closing operation, the two opening/closing movable contact portions come into contact with the first fixed terminal earlier than the energizing movable contact portion.

### CROSS REFERENCE TO RELATED APPLICATIONS

This application is a continuation application of International Application No. PCT/JP2016/084662, filed on Nov. 22, 2016, which claims priority based on the Article 8 of Patent Cooperation Treaty from prior Japanese Patent Application No. 2016-038055, filed on Feb. 29, 2016, the entire contents of which are incorporated herein by reference.

### TECHNICAL FIELD

The disclosure relates to a switch for opening and closing a current.

### BACKGROUND ART

As a switch having a sliding contact mechanism, for example, Patent Document 1 has disclosed a switch including: a base; a pair of fixed terminals vertically provided so as to face the upper surface of the base; an insulating wall integrated with at least one of the fixed terminals; a push button disposed so as to be vertically movable in an axial direction; and a slider that vertically moves integrally with the push button.

The switch disclosed in Patent Document 1 includes an elastic arm portion provided with movable contact portions respectively at both ends thereof, each coming into sliding contact with (sliding on) the fixed terminal or the insulating wall while pressing the same from one side, and the push button is vertically moved so that the movable contact portion provided on the elastic arm portion comes into contact with and separates from the fixed terminal.

In the switch disclosed in Patent Document 1, by provision of the elastic arm portions at both ends of the slider, a larger contact follow amount can be ensured when a predetermined contact force is ensured. Hence variations in contact force can be held small even when variations occur in the contact follow due to variations in component accuracy or assembling accuracy. This leads to the switch having small variations in operating characteristics. Further, a longitudinal space of the slider, namely a transverse space of the switch, can be effectively utilized to reduce the transverse size of the switch.

### PRIOR ART DOCUMENT

### Patent Document

Patent Document 1: Japanese Unexamined Patent Publication No. 2013-187154 (published on Sep. 19, 2013)

### SUMMARY OF THE INVENTION

### Problems to be Solved by the Invention

The switch disclosed in Patent Document 1 is suitable for the use for opening and closing a current of about 100 mA or smaller. However, for example when the switch is used for opening and closing a large current, arc discharge occurs between the movable contact portion and the fixed terminal at the time of switching between a conduction state and a non-conduction state (insulation state). The occurrence of the arc discharge can cause wear of the movable contact portion or the fixed terminal.

One or more embodiments have been made in view of the above problems, and may provide a switch with higher durability and reliability.

### Means for Solving the Problem

The switch according to one embodiment includes: a first fixed terminal and a second fixed terminal provided so as to face each other; a slider movable from a first position to a third position via a second position, and configured to allow conduction between the first fixed terminal and the second fixed terminal in the second position and the third position; and an insulating wall disposed side by side with respect to the first fixed terminal. The slider includes at least one first energizing movable contact portion, and at least two opening/closing movable contact portions separated from each other. Each of the first energizing movable contact portion and the at least two opening/closing movable contact portions slides while pressing the first fixed terminal and the insulating wall from one side. When the slider is in the first position, the first energizing movable contact portion and the at least two opening/closing movable contact portions are not in contact with the first fixed terminal. When the slider is in the second position, the first energizing movable contact portion is not in contact with the first fixed terminal, and the at least two opening/closing movable contact portions are in contact with the first fixed terminal. When the slider is in the third position, the first energizing movable contact portion and the at least two opening/closing movable contact portions are in contact with the first fixed terminal.

### Effect of the Invention

In one aspect, a switch with higher durability and reliability can be achieved.

### BRIEF DESCRIPTION OF THE DRAWINGS

FIG. 1 is a perspective view illustrating a switch of a first embodiment;

FIGS. 2A and 2B are diagrams illustrating a configuration of a switch according to a first embodiment; FIG. 2A is an exploded perspective view illustrating a switch as seen from above, and FIG. 2B is an exploded perspective view illustrating a switch as seen from below.

FIG. 3 is a perspective view illustrating a configuration of a slider of a switch according to a first embodiment.

FIG. 4 is a perspective view illustrating a state in which a first fixed terminal, a second fixed terminal, and a base of a switch according to a first embodiment are formed integrally.

FIG. 5 is a sectional view illustrating a state in which a switch according to a first embodiment is energized.

FIG. 6 is a perspective view illustrating a condition in which a switch according to a first embodiment switches between an energized state and a non-energized state.

FIG. 7 is a sectional view illustrating a state in which a switch according to a first embodiment is not energized.

FIG. 8 is a sectional view illustrating a configuration of a switch according to a second embodiment.

FIG. 9 is a sectional view illustrating a condition in which a movable contact portion of one elastic arm portion is in contact with a first sliding contact portion in closing operation of a switch according to a second embodiment.

FIG. 10 is a sectional view illustrating a condition in which a movable contact portion of other elastic arm portion is in contact with a second sliding contact portion in closing operation of a switch according to a second embodiment.

FIG. 11 is a sectional view illustrating a configuration of a switch according to a third embodiment.

FIG. 12 is a sectional view illustrating a state in which a switch according to a third embodiment is not energized.

### MODES FOR CARRYING OUT THE INVENTION

Hereinafter, embodiments will be described in detail.

### First Embodiment

A switch 1A in the first embodiment will be described.

(Configuration of Switch 1A)

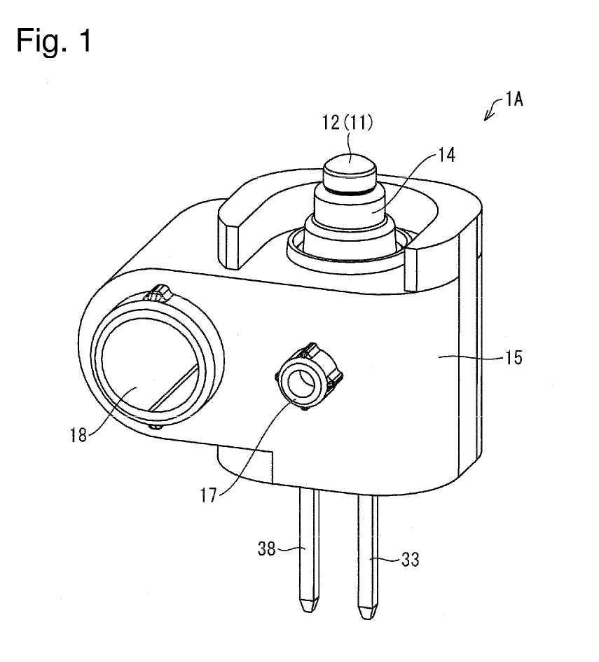

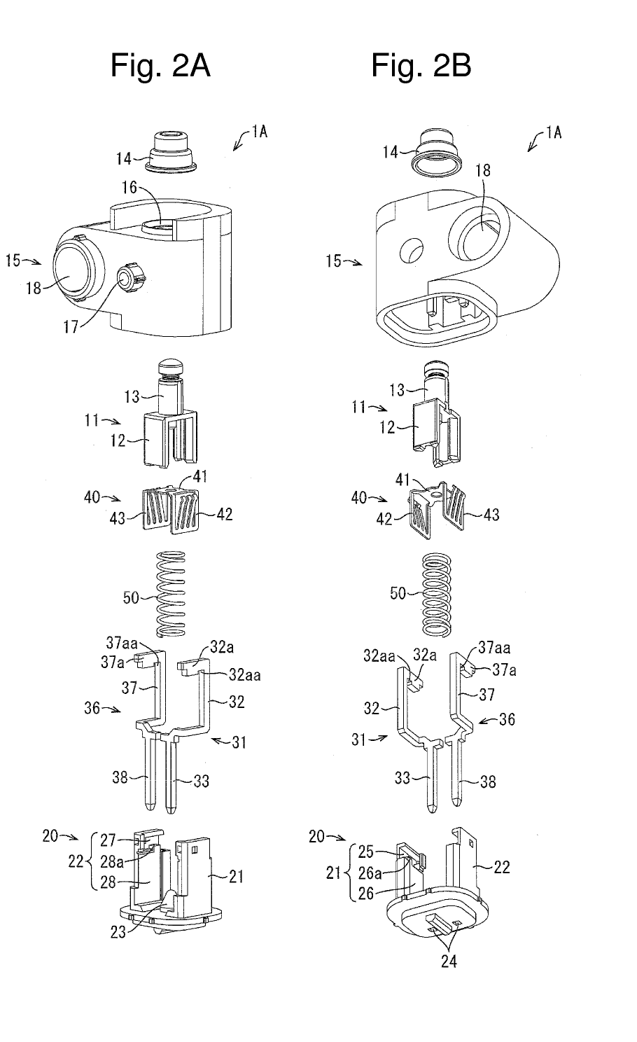

The configuration of the switch 1A in the first embodiment will be described with reference to FIGS. 1 to 3. FIG. 1 is a perspective view illustrating a switch 1A in the first embodiment. FIGS. 2A and 2B illustrate the configuration of the switch 1A in the first embodiment. FIG. 2A is an exploded perspective view of the switch 1A as seen from above, and FIG. 2B is an exploded perspective view of the switch 1A as seen from below.

As illustrated in FIGS. 1 and FIGS. 2A and 2B, the switch 1A includes a push button 11, a cap 14, a housing 15, a base 20, a first fixed terminal 31, a second fixed terminal 36, a slider 40, and a coil spring 50.

The push button 11 includes a pedestal 12 having a recess formed therein and a cylindrical press-receiving portion 13 extending upward in an axial direction from the pedestal 12. The push button 11 is disposed inside the housing 15 so as to be movable in an axial direction orthogonal to the base 20. The upper end of the press-receiving portion 13 projects upward from the housing 15 through the cylindrical cap 14. The push button 11 is configured to be movable in the axial direction by pressing of the press-receiving portion 13 from the outside.

The housing 15 is a box for housing the first fixed terminal 31, the second fixed terminal 36, the slider 40, the coil spring 50, and the like. The housing 15 has a shape with its bottom open. The housing 15 includes an annular groove 16 formed on the upper surface and through which the press-receiving portion 13 of the push button 11 passes, an annular positioning projection 17 horizontally projecting from the side surface, and an attachment hole 18 used for attaching the switch 1A to a device on which the switch 1A is to be mounted.

The base 20 is a plate-like member made of resin and closing the bottom opening of the housing 15, and has insulating properties. The base 20 includes two insulating walls 21, 22 formed integrally on the upper surface thereof and extending upward, a cylindrical rib 23 provided at the center of the base 20 and projecting upward, and two terminal holes 24.

The insulating wall 21 includes a burying groove 25 provided on the inner side surface thereof and an insulating portion 26 provided below the burying groove 25. At the upper end of the insulating portion 26, a projection 26a projecting upward is formed. The projection 26a is provided in a region where a movable contact portion 47a slides out of movable contact portions 47a, 47b, 47c described later.

Similarly, the insulating wall 22 includes a burying groove 27 provided on the inner side surface thereof and an insulating portion 28 provided below the burying groove 27. At the upper end of the insulating portion 28, a projection 28a projecting upward is formed. The projection 28a is provided in a region where a movable contact portion 49a slides out of movable contact portions 49a, 49b, 49c described later. The insulating walls 21, 22 are made of resin or the like, for example.

The first fixed terminal 31 is formed of metal and has conductivity. The first fixed terminal 31 includes a first slider-connecting terminal 32 in a substantially U-shape having a first sliding contact portion 32a formed at the upper end thereof, and a first external connection terminal 33 with an elongated shape extending downward from the lower end of the first slider-connecting terminal 32. Silver plating is applied to the first sliding contact portion 32a. In the first sliding contact portion 32a, a recess 32aa which opens downward is formed.

The second fixed terminal 36 is formed of metal and has conductivity. The second fixed terminal 36 includes a second slider-connecting terminal 37 in a substantially U-shape having a second sliding contact portion 37a formed at the upper end thereof, and a second external connection terminal 38 with an elongated shape extending downward from the lower end of the second slider-connecting terminal 37. Silver plating is applied to the second sliding contact portion 37a. In the second sliding contact portion 37a, a recess 37aa which opens downward is formed.

In this embodiment, as illustrated in FIGS. 2A and 2B, the first fixed terminal 31 and the second fixed terminal 36 are formed symmetrically, and the axial length of the first sliding contact portion 32a of the first fixed terminal 31 is the same as the axial length of the second sliding contact portion 37a of the second fixed terminal 36.

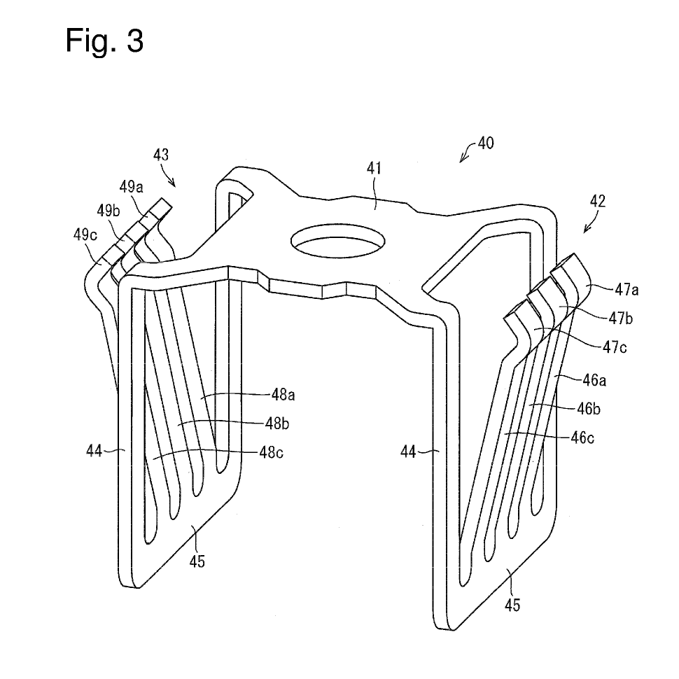

Next, the slider 40 will be described with reference to FIG. 3. FIG. 3 is a perspective view illustrating the configuration of the slider 40 in the first embodiment. The slider 40 is formed of metal and has conductivity. As illustrated in FIG. 3, the slider 40 includes a plate-like coupled body 41 and elastic arm portions 42, 43 formed by bending both ends of the coupled body 41.

The elastic arm portion 42 includes a support piece 44 of a rectangular frame body extending vertically downward from the end of the coupled body 41, a lower side 45 coupled to the support piece 44, and three elastic pieces 46a, 46b, 46c bent and raised in a V-shape outward from the lower side 45. The distal ends of the elastic pieces 46a, 46b, 46c are respectively provided with the movable contact portions 47a, 47b, 47c that slide while pressing the insulating portion 26 of the insulating wall 21 or the first sliding contact portion 32a of the first fixed terminal 31 from one side. Silver plating is applied to the surfaces of the movable contact portions 47a, 47b, 47c.

The elastic arm portion 43 includes a support piece 44 of a rectangular frame body extending vertically downward from the end of the coupled body 41, a lower side 45 coupled to the support piece 44, and three elastic pieces 48a, 48b, 48c bent and raised in a V-shape outward from the lower side 45. The distal ends of the elastic pieces 48a, 48b, 48c are respectively provided with the movable contact portions 49a, 49b, 49c that slide while pressing the insulating portion 28 of the insulating wall 22 or the second sliding contact portion 37a of the second fixed terminal 36 from one side. Silver plating is applied to the surfaces of the movable contact portions 49a, 49b, 49c.

The coil spring 50 is an elastic body disposed between the base 20 and the slider 40. The upper end of the coil spring 50 comes into contact with the coupled body 41 of the slider 40, and the lower end of the coil spring 50 receives the cylindrical rib 23 of the base 20 inserted thereinto. As a result, the coil spring 50 biases the coupled body 41 upward.

(Assembly of Switch 1A)

Next, an assembling method for the switch 1A in the first embodiment will be described.

In the assembling method for the switch 1A, first, the cap 14 is fitted into the annular groove 16 of the housing 15.

Next, the push button 11 is inserted inside the housing 15 so as to be movable in the axial direction, and the upper end of the press-receiving portion 13 is projected from the cap 14. Note that the slider 40 is insert molded in the recess of the pedestal 12 of the push button 11 in advance. Accordingly, the slider 40 is integrally provided on the push button 11 to reduce the number of parts and the number of assembling steps and eliminate variations in operating characteristics of the slider 40, thereby enabling enhancement of the contact reliability.

Next, the upper end of the coil spring 50 is brought into contact with the coupled body 41 of the slider 40.

Subsequently, the lower end of the coil spring 50 receives the cylindrical rib 23 of the base 20 inserted thereinto, the coil spring 50 is compressed, and the base 20 is attached to the opening of the housing 15.

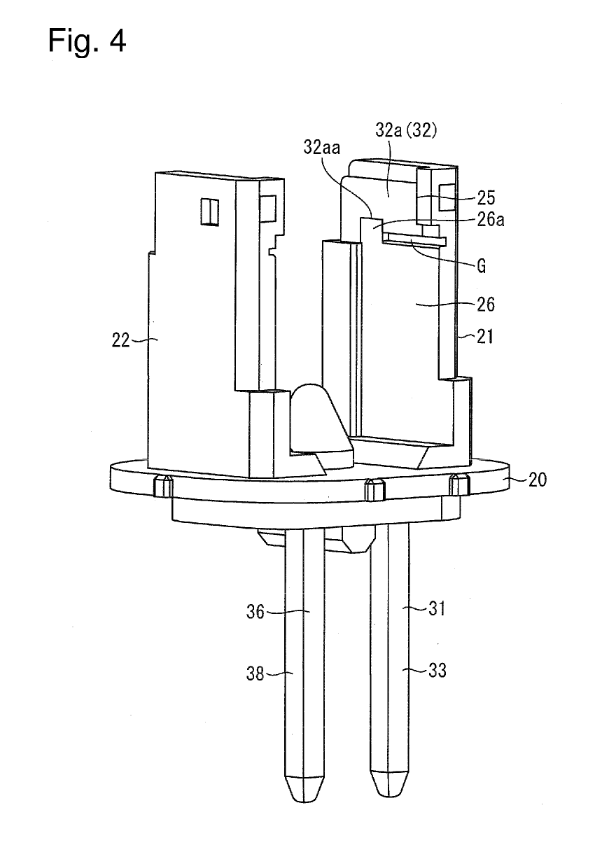

In the base 20, the first fixed terminal 31 and the second fixed terminal 36 are integrally formed in advance before assembly of the switch 1A. The integral formation of the first fixed terminal 31, the second fixed terminal 36, and the base 20 will be described with reference to FIG. 4. FIG. 4 is a perspective view illustrating a state in which the first fixed terminal 31, the second fixed terminal 36, and the base 20 are formed integrally. Here, the integral formation of the first fixed terminal 31 and the base 20 will be described. The second fixed terminal 36 and the base 20 are integrally formed in the same manner as the first fixed terminal 31 and the base 20 are integrally formed, and hence the description thereof will be omitted.

In the integral formation of the first fixed terminal 31 and the base 20, as illustrated in FIG. 4, the first sliding contact portion 32a of the first slider-connecting terminal 32 of the first fixed terminal 31 is buried into the burying groove 25 in the insulating wall 21 of the base 20. At this time, the projection 26a of the insulating portion 26 is inserted into the recess 32aa of the first sliding contact portion 32a. As a result, the insulating portion 26 of the insulating wall 21 and the first sliding contact portion 32a of the first fixed terminal 31 are disposed side by side.

The first sliding contact portion 32a of the first slider-connecting terminal 32 is flush with the insulating portion 26 of the insulating wall 21. That is, the surface of the first sliding contact portion 32a of the first slider-connecting terminal 32 and the surface of the insulating portion 26 of the insulating wall 21 are on the same plane.

Further, an air gap G (gap) as a space is formed between the first sliding contact portion 32a and the insulating portion 26 except where the projection 26a is inserted in the recess 32aa. Further, in the integral formation of the first fixed terminal 31 and the base 20, the first external connection terminal 33 is inserted into one of the two terminal holes 24. As a result, the first external connection terminal 33 is exposed downward from the terminal hole 24, and is connected to an external terminal (external circuit), not illustrated.

Similarly, by integrally molding the second fixed terminal 36 and the base 20, the first fixed terminal 31 and the second fixed terminal 36 are provided so as to face each other.

As described above, the base 20, in which the first fixed terminal 31 and the second fixed terminal 36 are integrally formed in advance, is mounted in the opening of the housing 15 to complete the assembly of the switch 1A.

(Operation of Switch 1A)

Next, the operation of the switch 1A in the first embodiment will be described. As for the operation of the switch 1A, the following two operations are performed. That is, the two operations below are performed. (1) By pressing the push button 11, the first fixed terminal 31 and the second fixed terminal 36 come into contact with the slider 40, the contact between the first fixed terminal 31 and the second fixed terminal 36 and the slider 40 is released from a state in which the switch 1A is energized (conduction state), and the first fixed terminal 31 and the second fixed terminal 36 come into contact with the insulating portion 26 and the insulating portion 28, respectively, to shift to a state in which the switch 1A is not energized (insulation state) (hereinafter, this operation is referred to as an opening operation). (2) By releasing the pressing of the push button 11, the first fixed terminal 31 and the second fixed terminal 36 come into contact with the insulating portion 26 and the insulating portion 28, respectively, and the first fixed terminal 31 and the second fixed terminal 36 come into contact with the slider 40 from the state in which the switch 1A is not energized (insulation state) to shift to the state in which the switch 1A is energized (conduction state) (hereinafter, this operation is referred to as a closing operation). In the following, each of the opening operation and the closing operation will be described in detail.

<Opening Operation>

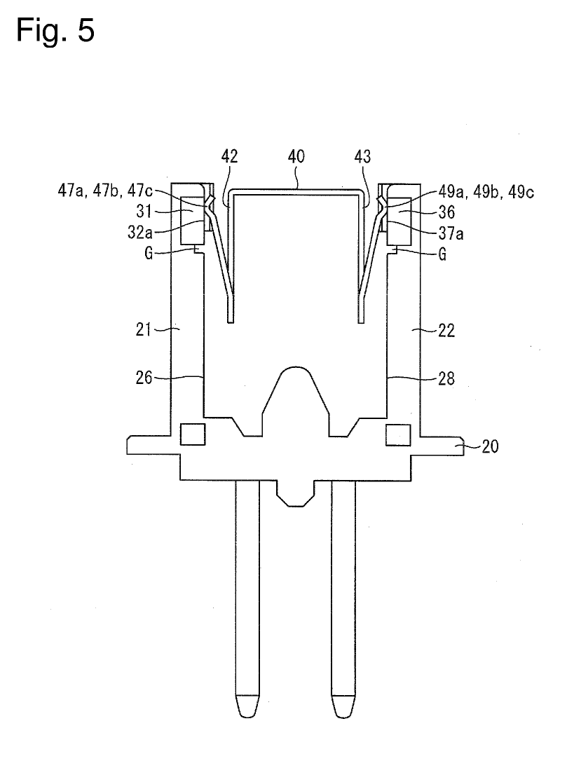

The opening operation of the switch 1A in the first embodiment will be described with reference to FIGS. 5 to 7.

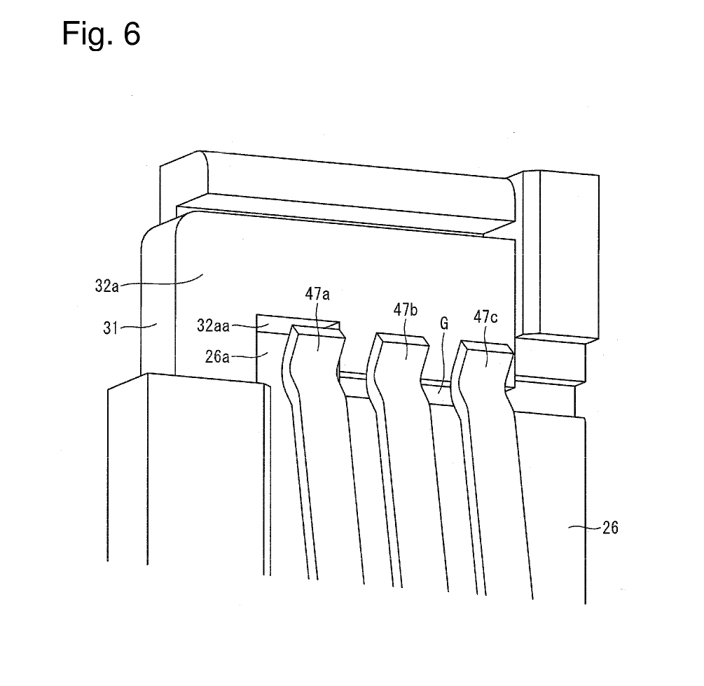

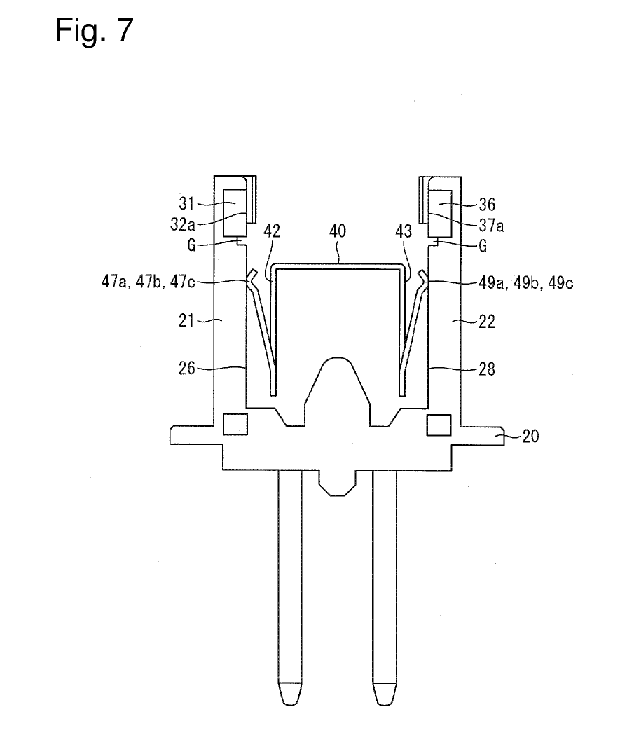

FIG. 5 is a sectional view illustrating a state in which the switch 1A in the first embodiment is energized. FIG. 6 is a perspective view illustrating a condition in which the switch 1A in the first embodiment switches between the energized state and the non-energized state. FIG. 7 is a sectional view illustrating a state in which the switch 1A in the first embodiment is not energized.

Before the opening operation of the switch 1A, the slider 40 is biased by the coil spring 50. Thus, as illustrated in FIG. 5, the slider 40 is located in an upper initial position (a position before the press-receiving portion 13 of the push button 11 is pressed, a third position). At this time, the movable contact portions 47a, 47b, 47c of the elastic arm portion 42 are in contact with the first sliding contact portion 32a of the first fixed terminal 31 and the movable contact portions 49a, 49b, 49c of the elastic arm portion 43 are in contact with the second sliding contact portion 37a of the second fixed terminal 36, while a current is flowing between the first fixed terminal 31 and the second fixed terminal 36 (i.e., the switch 1A is in the conduction state).

Next, the press-receiving portion 13 of the push button 11 is pressed from outside. Accordingly, the slider 40 is pressed by the push button 11 and moves downward in the axial direction against the biasing force of the coil spring 50.

When the slider 40 moves downward, the slider 40 first moves to a position (second position) in which the movable contact portion 47a out of the movable contact portions 47a, 47b, 47c of the elastic arm portion 42 comes into contact with the insulating portion 26. When the slider 40 is in the second position, with the projection 26a formed in a region of the insulating portion 26 where the movable contact portion 47a slides, the movable contact portions 47b, 47c come into the state of being in contact with the first sliding contact portion 32a (not in contact with the insulating portion 26) at the moment when the movable contact portion 47a comes into contact with the insulating portion 26.

Simultaneously with the contact between the movable contact portion 47a and the insulating portion 26, the movable contact portion 49a out of the movable contact portions 49a, 49b, 49c of the elastic arm portion 43 comes into contact with the insulating portion 28. In this state, the movable contact portions 47b, 47c of the elastic arm portion 42 are in contact with the first sliding contact portion 32a, and the movable contact portions 49b, 49c of the elastic arm portion 43 are in contact with the first sliding contact portion 32a. Hence the first fixed terminal 31 and the second fixed terminal 36 are kept in the conduction state (i.e., the switch 1A is in the conduction state).

When the press-receiving portion 13 of the push button 11 is further pressed, the slider 40 further moves downward, and as illustrated in FIG. 6, the movable contact portions 47b, 47c out of the movable contact portions 47a, 47b, 47c of the elastic arm portion 42 come into contact with the insulating portion 26. Simultaneously with the contact between the movable contact portions 47b, 47c and the insulating portion 26, the movable contact portions 49b, 49c out of the movable contact portions 49a, 49b, 49c of the elastic arm portion 43 come into contact with the insulating portion 28. This brings into the state where the movable contact portions 47a, 47b, 47c of the elastic arm portion 42 are in contact with the insulating portion 26, while the movable contact portions 49a, 49b, 49c of the elastic arm portion 43 are in contact with the insulating portion 28 (the slider 40 is in the first position). As a result, the first fixed terminal 31 and the second fixed terminal 36 enter the non-conduction state (i.e., a state in which the switch 1A is not energized (insulation state)).

When the press-receiving portion 13 of the push button 11 is further pushed, as illustrated in FIG. 7, the slider 40 further moves downward. Thus, the opening operation of the switch 1A is completed.

<Closing Operation>

Next, the closing operation of the switch 1A in the first embodiment will be described with reference to FIGS. 5 to 7.

Before the closing operation of the switch 1A is performed, as illustrated in FIG. 7, the switch 1A is in a non-energized state (insulation state), namely, the slider 40 is in the first position.

In this state, the pressing force of the push button 11 to the press-receiving portion 13 is released. Thus, the downward pressing of the press-receiving portion 13 to the slider 40 is released, so that the slider 40 moves upward in the axial direction due to the biasing force of the coil spring.

When the slider 40 moves upward, as illustrated in FIG. 6, the slider 40 moves to the position (second position) in which the movable contact portions 47b, 47c out of the movable contact portions 47a, 47b, 47c of the elastic arm portion 42 come into contact with the first sliding contact portion 32a. With the projection 26a formed in the region of the insulating portion 26 where the movable contact portion 47a slides, the movable contact portion 47a comes into the state of being in contact with the insulating portion 26 (not in contact with the first sliding contact portion 32a) at the moment when the movable contact portions 47b, 47c come into contact with the first sliding contact portion 32a.

Simultaneously with the contact between the movable contact portions 47b, 47c and the first sliding contact portion 32a, the movable contact portions 49b, 49c out of the movable contact portions 49a, 49b, 49c of the elastic arm portion 43 come into contact with the second sliding contact portion 37a.

As described above, the movable contact portions 47b, 47c come into contact with the first sliding contact portion 32a, and the movable contact portions 49b, 49c come into contact with the second sliding contact portion 37a, whereby the first fixed terminal 31 and the second fixed terminal 36 come into the conduction state (i.e., the switch 1A comes into the conduction state).

Further, when the slider 40 moves upward, the movable contact portion 47a comes into contact with the first sliding contact portion 32a and the movable contact portion 49a comes into contact with the second sliding contact portion 37a.

Then, as the slider 40 further moves upward, the slider 40 is located in the initial position (third position) as illustrated in FIG. 5. Thus, the closing operation of the switch 1A is completed.

As described above, in the switch 1A according to the first embodiment, the elastic arm portion 42 and the elastic arm portion 43 of the slider 40 respectively include the three movable contact portions 47a, 47b, 47c and the three movable contact portions 49a, 49b, 49c. The movable contact portion 47a out of the three movable contact portions 47a, 47b, 47c of the elastic arm portion 42 has a function as an energizing contact (first energizing movable contact portion), and the movable contact portions 47b, 47c have functions as opening/closing contacts. Similarly, the movable contact portion 49a out of the three movable contact portions 49a, 49b, 49c of the elastic arm portion 43 has a function as an energizing contact (first energizing movable contact portion), and the movable contact portions 49b, 49c have functions as opening/closing contacts.

(Characteristics of Switch 1A)

Generally, in a switch that opens and closes a large current (e.g., a current of several hundred milliamperes or larger), arc discharge occurs at a contact point of the switch at the time of switching between the energized state and the non-energized state. When the arc discharge occurs, the temperature at the contact point becomes high due to the arc discharge and the terminal melts and then wears, which is problematic.

Therefore, in the switch 1A of the first embodiment, as described above, the slider 40 includes the three movable contact portions 47a, 47b, 47c on one side and the three movable contact portions 49a, 49b, 49c on the other side.

Then, in the opening operation of the switch 1A, when the state switches from the energized state to the non-energized state, first, the movable contact portion 47a and the movable contact portion 49a come into contact with the insulating portion 26 and the insulating portion 28, respectively, and then the movable contact portions 47b, 47c and the movable contact portions 49b, 49c come into contact with the insulating portion 26 and the insulating portion 28, respectively. Hence the arc discharge occurs between the movable contact portions 47b, 47c and the first sliding contact portion 32a, or between the movable contact portions 49b, 49c and the second sliding contact portion 37a. That is, the arc discharge does not occur between the movable contact portion 47a and the first sliding contact portion 32a, or between the movable contact portion 49a and the second sliding contact portion 37a. As a result, at least the movable contact portion 47a and the movable contact portion 49a can be prevented from wearing due to the arc discharge. Therefore, as compared with the conventional switch, the switch 1A of the first embodiment is a switch capable of opening and closing a high current as well as a switch with improved durability and reliability.

Further, in the closing operation of the switch 1A, when the pressing force of the push button 11 to the press-receiving portion 13 is released, the slider 40 moves from the first position to the second position. Thereby, the movable contact portions 47b, 47c out of the movable contact portions 47a, 47b, 47c come into contact with the first sliding contact portion 32a earlier than the movable contact portion 47a, and the movable contact portions 49b, 49c out of the movable contact portions 49a, 49b, 49c come into contact with the second sliding contact portion 37a earlier than the contact portion 49a. Hence the arc discharge occurs between the movable contact portions 47b, 47c and the first sliding contact portion 32a, or between the movable contact portions 49b, 49c and the second sliding contact portion 37a. That is, the arc discharge does not occur between the movable contact portion 47a and the first sliding contact portion 32a, or between the movable contact portion 49a and the second sliding contact portion 37a. As a result, at least the movable contact portion 47a and the movable contact portion 49a can be prevented from wearing due to the arc discharge. Therefore, in the closing operation of the switch 1A, at least the movable contact portion 47a and the movable contact portion 49a come into the conduction state with the first fixed terminal 31 and the second fixed terminal 36, respectively. Thus, as compared with the conventional switch, the switch 1A of the first embodiment is a switch capable of opening and closing a high current and holding a stable conduction state, as well as a switch with improved durability and reliability.

Further, the switch 1A of the first embodiment has a configuration where the elastic arm portion 42 includes the two movable contact portions 47b, 47c as the opening/closing contacts. With this configuration, when the arc discharge occurs between the movable contact portions 47b, 47c and the first sliding contact portion 32a, the wear of the movable contact portion due to the arc discharge can be dispersed, to further improve the durability and the reliability of the switch 1A. For example, when the arc discharge occurs in the movable contact portions 47b, 47c at the same time, the current of each arc discharge can be reduced, and hence the wear of the movable contact portions 47b, 47c can be reduced. Further, for example, when one of the movable contact portions 47b, 47c wears, the other movable contact portion first comes into contact with the first sliding contact portion 32a in the closing operation. Then, since the arc discharge occurs between the other movable contact portion and the first sliding contact portion 32a this time, this movable contact portion wears. In this manner, the durability and reliability of the switch 1A can be improved by alternate wear of the movable contact portions 47b, 47c.

Similarly, the switch 1A of the first embodiment has a configuration where the elastic arm portion 43 includes the two movable contact portions 49b, 49c as the opening/closing contacts. With this configuration, when the arc discharge occurs between the movable contact portions 49b, 49c and the second sliding contact portion 37a, the wear of the movable contact portion due to the arc discharge can be dispersed, to further improve the durability and the reliability of the switch 1A.

The switch 1A of the first embodiment has the following configuration. The elastic arm portion 42 includes the two movable contact portions 47b, 47c as the opening/closing contacts, and the elastic arm portion 43 includes the two movable contact portions 49b, 49c as the opening/closing contacts. At the time of the closing operation, the movable contact portions 47b, 47c come into contact with the first sliding contact portion 32a, and at the same time, the movable contact portions 49b, 49c come into contact with the second sliding contact portion 37a. With this configuration, a place where the arc discharge occurs at the time of the closing operation can be dispersed into four places, respectively between the movable contact portion 47b or 47c and the first sliding contact portion 32a, and between the movable contact portion 49b or 49c and the second sliding contact portion 37a. Thus, the erosion of the movable contact portion due to the arc discharge can be dispersed, to further improve the durability and reliability of the switch 1A.

The switch 1A according to the first embodiment has the configuration where the elastic arm portion 42 includes one movable contact portion 47a as the energizing contact and the two movable contact portions 47b, 47c as the opening/closing contacts, and the elastic arm portion 43 includes one movable contact portion 49a as the energizing contact and the two movable contact portions 49b, 49c as the opening/closing contacts. However, the switch of one or more embodiments is not limited to this configuration.

That is, the switch of one or more embodiments may have a configuration where each of the two elastic arm portions includes at least two movable contact portions as the opening/closing contacts, or a configuration where each of the two elastic arm portions includes three or more movable contact portions as the opening/closing contacts. Increasing the number of movable contact portions as the opening/closing contacts enables dispersion of the place where the arc discharge occurs at the time of the closing operation, and thus enables improvement in durability and reliability of the switch.

The switch of one or more embodiments may have a configuration where each of the two elastic arm portions includes at least one movable contact portion as the energizing contact, or a configuration where each of the two elastic arm portions includes two or more movable contact portions as the energizing contacts. Further, the switch of one or more embodiments may have a configuration where the number of movable contact portions as the energizing contacts and the number of movable contact portions as the opening/closing contacts in the two elastic arm portions are different from each other.

In the switch 1A of the first embodiment, the air gap G is formed between the first sliding contact portion 32a and the insulating portion 26 other than the place where the projection 26a is inserted in the recess 32aa, and the air gap G is formed between the second sliding contact portion 37a and the insulating portion 28 other than the place where the projection 28a is inserted in the recess 37aa. That is, the first sliding contact portion 32a and the insulating portion 26 are separated from each other in a position corresponding to the movable contact portions 47b, 47c (opening/closing contacts). Further, the second sliding contact portion 37a and the insulating portion 28 are separated from each other in a position corresponding to the movable contact portions 49b, 49c (opening/closing contacts). As a result, when the arc discharge occurs between the movable contact portions 47b, 47c and the first sliding contact portion 32a at the time of switching between the energized state and the non-energized state, the insulating portion 26 can be prevented from melting due to the arc discharge. When the arc discharge occurs between the movable contact portions 49b, 49c and the second sliding contact portion 37a at the time of switching between the energized state and the non-energized state, the insulating portion 28 can be prevented from melting due to the arc discharge. It is thereby possible to prevent fluctuation of the contact opening/closing position due to dissolution of the insulating portions 26, 28, caused by the arc discharge.

Further, provision of the air gap G enables the slider 40 to rub into the air gap G a sliding abrasion powder, generated by sliding between the slider 40 and the insulating portions 26, 28, and a foreign matter intruding from the outside. It is thus possible to prevent the sliding abrasion powder and foreign matter from adhering to the first sliding contact portion 32a or the second sliding contact portion 37a. Accordingly, it is possible to prevent poor contact between the movable contact portions 47a, 47b, 47c and the first sliding contact portion 32a and poor contact between the movable contact portions 49a, 49b, 49c and the second sliding contact portion 37a.

(Modifications)

Note that a third fixed terminal and a fourth fixed terminal may be provided, which face each other in a vertical direction to the direction in which the first fixed terminal 31 and the second fixed terminal 36 face each other. Between the third fixed terminal and the fourth fixed terminal, another slider is provided so as to overlap with the slider 40. For example, in the case of connecting the first to fourth fixed terminals in series, the second fixed terminal and the third fixed terminal are connected, and the slider 40 and the other slider are insulated from each other. For example, in the case of connecting the first fixed terminal and the third fixed terminal in parallel and connecting the second fixed terminal and the fourth fixed terminal in parallel, the first fixed terminal and the third fixed terminal are connected to each other while the second fixed terminal and the fourth fixed terminal are connected to each other, and the slider 40 and the other slider are connected to each other. Note that the first to fourth fixed terminals may be connected in other combinations.

In the switch 1A, the slider is disposed in a position where the axis of the coil spring passes. This eliminates the need to separately ensure a space for disposing the slider and can ensure a large distance between the first fixed terminal 31 and the second fixed terminal 36. Hence it is possible to make the insulation reliability high and reduce the size of the switch.

### Second Embodiment

Another embodiment will be described as follows. For convenience of description, members having the same functions as the members described in the above embodiment are denoted by the same reference numerals, and the description thereof is omitted.

In the switch 1A in the first embodiment, the axial length of the first sliding contact portion 32a of the first fixed terminal 31 and the axial length of the second sliding contact portion 37a of the second fixed terminal 36 are the same.

In contrast, a switch 1B in the second embodiment is different from the switch 1A in the first embodiment in that in the direction in which the slider 40 moves, the length of a first sliding contact portion 72a of a first fixed terminal 71 is different from the length of the second sliding contact portion 37a of the second fixed terminal 36.

(Configuration of Switch 1B)

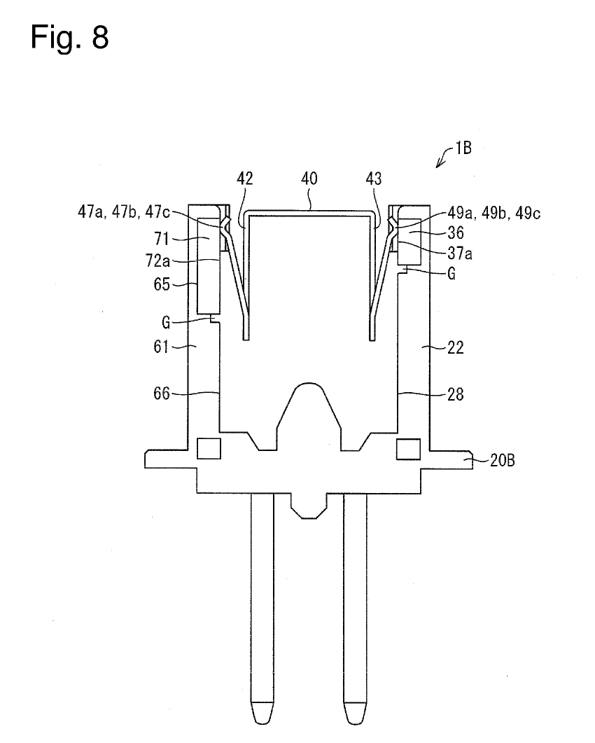

The configuration of the switch 1B in the second embodiment will be described with reference to FIG. 8. FIG. 8 is a sectional view illustrating the configuration of the switch 1B in the second embodiment.

As illustrated in FIG. 8, the switch 1B includes the first fixed terminal 71 and a base 20B.

The first fixed terminal 71 is formed such that the axial length of the first sliding contact portion 72a is larger than the axial length of the second sliding contact portion 37a of the second fixed terminal 36.

The base 20B includes an insulating wall 61 and the insulating wall 22. The insulating wall 61 includes a burying groove 65 provided on the inner side surface thereof and an insulating portion 66 provided below the burying groove 65. The burying groove 65 is a groove for burying the first sliding contact portion 72a of the first fixed terminal 71. In the switch 1B of the second embodiment, the burying groove 65 is formed to have a large length in an axially lower part as compared with that of the burying groove 25 in the first embodiment. However, the switch of one or more embodiments is not limited to this configuration. That is, the switch needs to have a configuration where the first sliding contact portion 72a is formed so as to have a larger axial length than the axial length of the second sliding contact portion 37a of the second fixed terminal 36. For example, the switch may have a configuration where the burying groove 65 is formed so as to have a large length in an axially upper part as compared with the length of the burying groove 25 in the first embodiment.

(Closing Operation of Switch 1B)

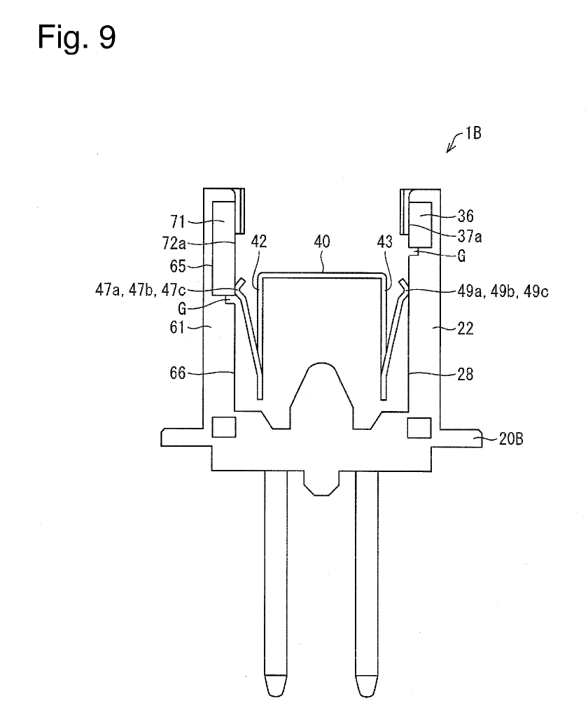

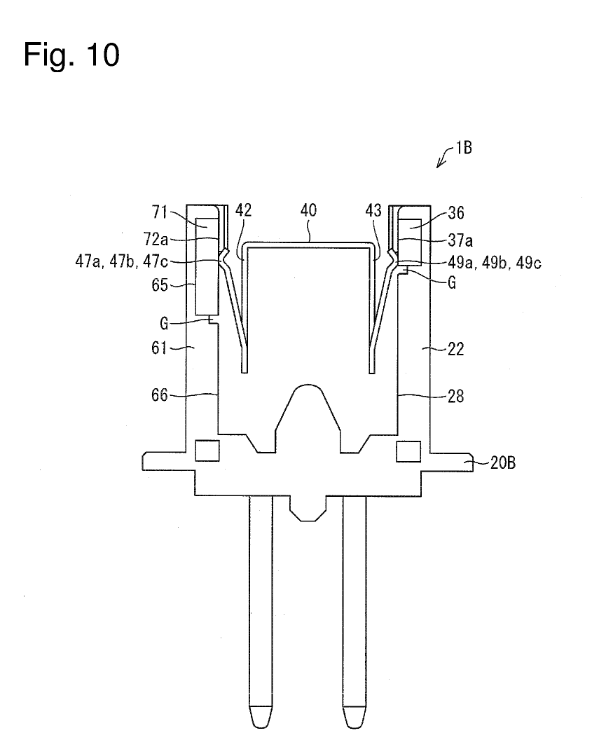

Next, the closing operation of the switch 1B in the second embodiment will be described with reference to FIGS. 9 and 10. FIG. 9 is a sectional view illustrating a condition in which the movable contact portions 47b, 47c of the elastic arm portion 42 are in contact with the first sliding contact portion 72a in the closing operation of the switch 1B in the second embodiment. FIG. 10 is a sectional view illustrating a condition in which the movable contact portions 49b, 49c of the elastic arm portion 43 are in contact with the second sliding contact portion 37a in the closing operation of the switch 1B in the second embodiment.

In the closing operation of the switch 1B, first, in a state where the switch 1B is not energized (i.e., the slider 40 is pressed by the push button 11 and the movable contact portions 47a, 47b, 47c (second energizing movable contact portions) of the elastic arm portion 42 are in contact with the insulating portion 66 of the insulating wall 61 and the movable contact portions 49a, 49b, 49c of the elastic arm portion 43 are in contact with the insulating portion 28 of the insulating wall 22), the pressing force of the push button 11 to the press-receiving portion 13 is released. Thus, the downward pressing of the press-receiving portion 13 to the slider 40 is released, so that the slider 40 moves upward in the axial direction due to the biasing force of the coil spring.

When the slider 40 moves upward (third position), as illustrated in FIG. 9, the movable contact portions 47a, 47b, 47c of the elastic arm portion 42 come into contact with the first sliding contact portion 72a. At this stage, there is no conduction between the first fixed terminal 71 and the second fixed terminal 36.

Next, when the slider 40 further moves upward, as illustrated in FIG. 10, the movable contact portions 49a, 49b, 49c of the elastic arm portion 43 come into contact with the second sliding contact portion 37a. At this time, similarly to the closing operation in the first embodiment, after the contact between the movable contact portions 49b, 49c out of the movable contact portions 49a, 49b, 49c and the second sliding contact portion 37a (second position), the movable contact portion 49a (first energizing movable contact portion) comes into contact with the second sliding contact portion 37a (first position). This leads to occurrence of the arc discharge between the movable contact portions 49b, 49c and the second sliding contact portion 37a. That is, the arc discharge does not occur in the movable contact portion 49a or the second sliding contact portion 37a. As a result, at least the movable contact portion 49a out of the movable contact portions 49a, 49b, 49c can be prevented from wearing due to the arc discharge.

When the slider 40 further moves upward, the slider 40 is located in the initial position. Thus, the closing operation of the switch 1B is completed.

(Features of Switch 1B)

In the switch 1B in the second embodiment, in the closing operation, after the contact between the movable contact portions 47a, 47b, 47c of the elastic arm portion 42 and the first sliding contact portion 72a, the movable contact portions 49a, 49b, 49c of the elastic arm portion 43 come into contact with the second sliding contact portion 37a to bring the switch 1B into the conduction state. As a result, the arc discharge does not occur between the movable contact portions 47a, 47b, 47c and the first sliding contact portion 72a, and the arc discharge occurs between the movable contact portions 49b, 49c and the second sliding contact portion 37a.

When a conductive film formed on the movable contact portion and the fixed terminal contains metal (e.g., silver) liable to ionize into cations, the arc discharge occurs from the positive electrode (anode) toward the negative electrode (cathode). Hence the wear of the terminal due to the arc discharge occurs at the terminal of the positive electrode (anode). Therefore, in the switch 1B in the second embodiment, the first external connection terminal 33 and the second external connection terminal 38 are respectively connected to external terminals such that the second fixed terminal 36 serves as the anode. Thus, in the switch 1B, when the arc discharge occurs between the movable contact portions 49b, 49c and the second sliding contact portion 37a, the arc discharge occurs from the second sliding contact portion 37a side reliably.

Here, the conduction between the movable contact portions 49b, 49c and the second sliding contact portion 37a is performed through a silver film formed on the movable contact portions 49b, 49c and a silver film formed on the second sliding contact portion 37a. Further, the elastic pieces 48a, 48b, 48c are required to have elasticity (springiness) for sliding the second sliding contact portion 37a and the insulating portion 28, and hence the elastic pieces 48a, 48b, 48c are manufactured by processing a plate material or the like. When the silver film has a large film thickness, cracks may occur in the silver film during bending processing. For this reason, the film thickness of the silver film on the elastic pieces 48a, 48b, 48c cannot be increased. Hence the film thickness of the silver film formed on the movable contact portions 49a, 49b, 49c cannot be increased. On the other hand, the film thickness of the silver film formed on the second sliding contact portion 37a can be increased.

Therefore, in the switch 1B in the second embodiment, the film thickness of the silver plating formed on the second sliding contact portion 37a is larger than the film thickness of the silver plating formed on the movable contact portions 49a, 49b, 49c, and when the arc discharge occurs between the movable contact portions 49b, 49c and the second sliding contact portion 37a, the second sliding contact portion 37a side wears due to the arc discharge. It is thereby possible to improve the durability of the switch 1B.

The configuration where the first fixed terminal 71 and the second fixed terminal 36 are asymmetrical with respect to the slider 40 has been described here, but one or more embodiments are not limited thereto. For example, the switch may have a configuration where the first fixed terminal 31 and the second fixed terminal 36 are symmetrical with respect to the slider 40 (the configuration illustrated in FIG. 5). In addition, the slider 40 may be configured to be asymmetrical with respect to the axis. That is, in the axial direction (the direction in which the slider moves), the positions of the movable contact portions 47b, 47c (second energizing movable contact portions) may be different from the positions of the movable contact portions 49b, 49c (opening/closing movable contact portions).

The switch 1B has a configuration where the first sliding contact portion 72a of the first fixed terminal 71 is longer than the second sliding contact portion 37a of the second fixed terminal 36 in the direction in which the slider 40 moves. However, the switch of one or more embodiments is not limited thereto. That is, the switch may have a configuration where the length of the first fixed terminal and the length of the second fixed terminal may be different from each other in the direction in which the slider 40 moves. For example, even when the second sliding contact portion of the second fixed terminal is longer than the second sliding contact portion of the first fixed terminal, a similar operation is performed as long as the lower end of the second sliding contact portion is located axially below the lower end of the first sliding contact portion.

### Third Embodiment

Another embodiment will be described as follows. For convenience of description, members having the same functions as the members described in the above embodiment are denoted by the same reference numerals, and the description thereof is omitted.

A switch 1C in the third embodiment is different from those of the other embodiments in that the elastic arm portion 43 of the slider 40 does not come into contact with the insulating portion of the base in the non-energized state (insulation state).

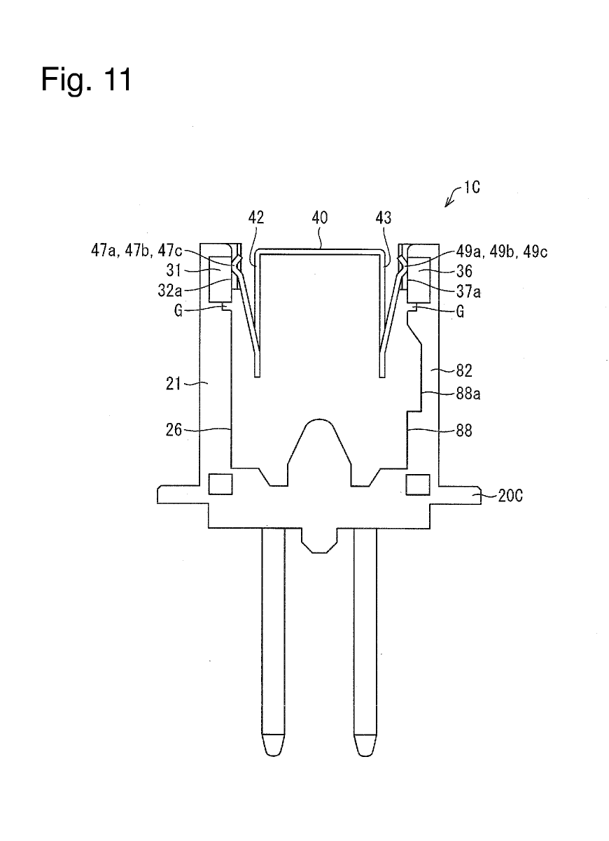

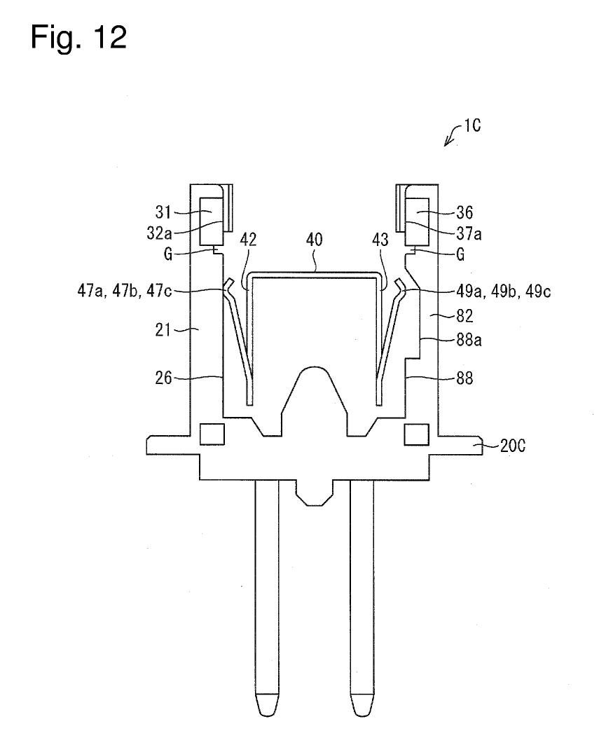

The switch 1C in the third embodiment will be described with reference to FIGS. 11 and 12. FIG. 11 is a sectional view illustrating the configuration of the switch 1C in the third embodiment. FIG. 12 is a sectional view illustrating a state in which the switch 1C in the third embodiment is not energized.

As illustrated in FIG. 11, the switch 1C includes a base 20C.

The base 20C has an insulating wall 82. The insulating wall 82 includes an insulating portion 88, and the insulating portion 88 is provided with a recess 88a opening toward the slider 40 side.

Next, a condition in which the switch 1C is in the non-energized (insulation state) will be described. When the switch 1C is in the non-energized state (i.e., the switch 1C is in the insulation state), as illustrated in FIG. 12, the movable contact portions 49a, 49b, 49c of the elastic arm portion 43 are not in contact with the insulating portion 88 since the recess 88a opening toward the slider 40 side is formed in the insulating portion 88. That is, in the state where the switch 1C is not energized (insulation state), the movable contact portions 49a, 49b, 49c of the elastic arm portion 43 and the insulating portion 88 are spatially separated from each other.

Thus, the switch 1C of the third embodiment can prevent occurrence of insulation failure due to contact abrasion powder or carbonization of resin/grease. That is, it is possible to improve insulating properties in the state where the switch 1C is not energized (insulation state).

The recess 88a may also be provided in the other insulating portion 26. In this case, the movable contact portions 47a, 47b, 47c, 49a, 49b, 49c of the elastic arm portions 43 on both sides are spatially separated from the insulating portions 26, 88.

[Summary]

The switch according to one embodiment includes: a first fixed terminal and a second fixed terminal provided so as to face each other; a slider movable from a first position to a third position via a second position, and configured to allow conduction between the first fixed terminal and the second fixed terminal in the second position and the third position; and an insulating wall disposed side by side with respect to the first fixed terminal. The slider includes at least one first energizing movable contact portion, and at least two opening/closing movable contact portions separated from each other. Each of the first energizing movable contact portion and the at least two opening/closing movable contact portions slides while pressing the first fixed terminal and the insulating wall from one side. When the slider is in the first position, the first energizing movable contact portion and the at least two opening/closing movable contact portions are not in contact with the first fixed terminal. When the slider is in the second position, the first energizing movable contact portion is not in contact with the first fixed terminal, and the at least two opening/closing movable contact portions are in contact with the first fixed terminal. When the slider is in the third position, the first energizing movable contact portion and the at least two opening/closing movable contact portions are in contact with the first fixed terminal.

According to the above configuration, when the switch starts conducting, at least two opening/closing movable contact portions come into contact with the first fixed terminal earlier than the first energizing movable contact portion. Therefore, the arc discharge occurs between the first fixed terminal and the at least two opening/closing movable contact portions, and does not occur between the first fixed terminal and the first energizing movable contact portion. It is possible to reduce the wear of the first energizing movable contact portion, and thus possible to ensure highly reliable conduction between the first energizing movable contact portion and the first fixed terminal after the slider has moved to the third position. With the at least two opening/closing movable contact portions being separated from each other, it is possible to prevent the arc discharge having occurred in one place from simultaneously causing damage to the at least two opening/closing movable contact portions. Further, the current is dispersed by the at least two opening/closing movable contact portions to enable reduction in damage having occurred due to the arc discharge. It is thereby possible to improve the durability and reliability of the switch.

The slider may include at least one second energizing movable contact portion, the second energizing movable contact portion may slide while pressing the second fixed terminal from one side, and when the slider is in the second position and the third position, the second energizing movable contact portion may be in contact with the second fixed terminal.

According to the above configuration, in the state where the second energizing movable contact portion is in contact with the second fixed terminal, the opening/closing movable contact portion and the first fixed terminal come into contact or lose contact with each other. Therefore, the arc discharge does not occur between the second energizing movable contact portion and the second fixed terminal, and the arc discharge occurs between the opening/closing movable contact portion and the first fixed terminal. Therefore, the wear of the second energizing movable contact portion and the second fixed terminal can be reduced. Further, the use of the first fixed terminal as the anode causes occurrence of the arc discharge from the first fixed terminal reliably and thus enables reduction in wear of the opening/closing movable contact portion.

The length of the first fixed terminal and the length of the second fixed terminal may be different from each other in the direction in which the slider moves.

The position of the at least two opening/closing movable contact portions may be different from the position of the second energizing movable contact portion in the direction in which the slider moves.

The thickness of the conductive film formed on the first fixed terminal may be larger than the thickness of the conductive film formed on the at least two opening/closing movable contact portions.

According to the above configuration, the durability of the first fixed terminal can be increased with respect to the arc discharge. Therefore, the durability of the switch can be improved.

It may be configured such that the insulating wall has a recess, and when the slider is in the first position, the energizing movable contact portion and the at least two opening/closing movable contact portions are disposed in positions corresponding to the recess and are not in contact with the insulating wall.

According to the above configuration, by spatially separating the energizing movable contact portion and the at least two opening/closing movable contact portions from the insulating wall, even when a foreign matter or a sliding abrasion powder exists, the insulation reliability can be improved.

It may be configured such that a gap is provided between the first fixed terminal and the insulating wall in a position corresponding to the at least two opening/closing movable contact portions.

According to the above configuration, it is possible to prevent the insulating wall from wearing due to the arc discharge. Further, the reliability of conduction between the at least two opening/closing movable contact portions and the first fixed terminal can be improved by dropping the foreign matter or the sliding abrasion powder into the gap.

The present invention is not restricted to each of the embodiments described above, but can be subjected to a variety of changes in the scope shown in the claims. An embodiment obtained by appropriately combining technical units disclosed respectively in different embodiments is also included in a technical scope of the present invention.

### DESCRIPTION OF SYMBOLS

1A to 1C switch
11 push button
20, 20B, 20C base
21, 22, 61, 82 insulating wall
26, 28, 66, 88 insulating portion
31, 71 first fixed terminal
32 first slider-connecting terminal
32a, 72a first sliding contact portion
36 second fixed terminal
37 second slider-connecting terminal
37a second sliding contact portion
40 slider
42, 43 elastic arm portion
47a, 49a movable contact portion (energizing movable contact portion)
47b, 47c movable contact portion (opening/closing movable contact portion, energizing movable contact portion)
49b, 49c movable contact portion (opening/closing movable contact portion)
50 coil spring

1. A switch comprising:
a first fixed terminal and a second fixed terminal provided so as to face each other;
a slider movable from a first position to a third position via a second position, and configured to allow conduction between the first fixed terminal and the second fixed terminal in the second position and the third position; and
an insulating wall disposed side by side with respect to the first fixed terminal,
wherein
the slider includes at least one first energizing movable contact portion, and at least two opening/closing movable contact portions separated from each other,
each of the first energizing movable contact portion and the at least two opening/closing movable contact portions slides while pressing the first fixed terminal and the insulating wall from one side,
when the slider is in the first position, the first energizing movable contact portion and the at least two opening/closing movable contact portions are not in contact with the first fixed terminal,
when the slider is in the second position, the first energizing movable contact portion is not in contact with the first fixed terminal, and the at least two opening/closing movable contact portions are in contact with the first fixed terminal, and
when the slider is in the third position, the first energizing movable contact portion and the at least two opening/closing movable contact portions are in contact with the first fixed terminal.

2. The switch according to claim 1, wherein
the slider includes at least one second energizing movable contact portion, the second energizing movable contact portion slides while pressing the second fixed terminal from one side, and
when the slider is in the second position and the third position, the second energizing movable contact portion is in contact with the second fixed terminal.

3. The switch according to claim 2, wherein a length of the first fixed terminal and a length of the second fixed terminal are different from each other in a direction in which the slider moves.

4. The switch according to claim 2, wherein a position of the at least two opening/closing movable contact portions and a position of the second energizing movable contact portion are different from each other in the direction in which the slider moves.

5. The switch according to claim 1, wherein a thickness of a conductive film formed on the first fixed terminal is larger than a thickness of a conductive film formed on the at least two opening/closing movable contact portions.

6. The switch according to claim 1, wherein
the insulating wall has a recess, and
when the slider is in the first position, the first energizing movable contact portion and the at least two opening/closing movable contact portions are located at positions corresponding to the recess and are not in contact with the insulating wall.

7. The switch according to claim 1, wherein a gap is provided between the first fixed terminal and the insulating wall in a position corresponding to the at least two opening/closing movable contact portions.

8. The switch according to claim 3, wherein a position of the at least two opening/closing movable contact portions and a position of the second energizing movable contact portion are different from each other in the direction in which the slider moves.

9. The switch according to claim 2, wherein a thickness of a conductive film formed on the first fixed terminal is larger than a thickness of a conductive film formed on the at least two opening/closing movable contact portions.

10. The switch according to claim 3, wherein a thickness of a conductive film formed on the first fixed terminal is larger than a thickness of a conductive film formed on the at least two opening/closing movable contact portions.

11. The switch according to claim 4, wherein a thickness of a conductive film formed on the first fixed terminal is larger than a thickness of a conductive film formed on the at least two opening/closing movable contact portions.

12. The switch according to claim 8, wherein a thickness of a conductive film formed on the first fixed terminal is larger than a thickness of a conductive film formed on the at least two opening/closing movable contact portions.
